(19) United States
(12) Patent Application Publication
(10) Pub. No.: US 2021/0010412 A1
(43) Pub. Date: Jan. 14, 2021

(54) OIL SUPPLY SYSTEM FOR INTEGRATED TURBOCHARGER

(71) Applicants: Michael P Schmidt, Highland, MI (US); Jeffrey Brand, Highland, MI (US); Constantin Hagiu, Windsor (CA); Nikhil P Madathil, Rochester Hills, MI (US)

(72) Inventors: Michael P Schmidt, Highland, MI (US); Jeffrey Brand, Highland, MI (US); Constantin Hagiu, Windsor (CA); Nikhil P Madathil, Rochester Hills, MI (US)

(21) Appl. No.: 16/924,450

(22) Filed: Jul. 9, 2020

Related U.S. Application Data
(60) Provisional application No. 62/872,745, filed on Jul. 11, 2019.

(51) Int. Cl. F02B 39/14; F02F 11/00; F02B 33/40; F16J 15/06

(52) U.S. Cl. CPC F02B 39/14; F16J 15/062; F02B 33/40; F02F 11/002

(57) ABSTRACT

A cylinder head assembly for an internal combustion engine includes a cast cylinder head having at least one oil gallery, a turbocharger housing integrally cast with the cylinder head, and a turbocharger cartridge assembly configured to be inserted into the turbocharger housing and including at least one bearing rotatably supporting a shaft coupled between a compressor wheel and a turbine wheel. A lubricant supply system having a lubricant passage formed within the turbocharger housing is configured to supply oil from the at least one oil gallery to the turbocharger cartridge assembly to lubricate the at least one bearing.

### CROSS REFERENCE TO RELATED APPLICATION

This application claims the benefit of U.S. Provisional Pat. App. No. 62/872,745, fled on Jul. 11, 2019, the contents of which are incorporated herein by reference thereto.

### FIELD

The present application relates generally to turbocharged internal combustion engines and, more particularly, to an internal combustion engine having a cylinder head with an integrated turbocharger.

### BACKGROUND

Turbocharger systems typically account for a good portion of the cost of an engine. Moreover, typical gasoline engine turbine housings have significant amounts of nickel and chrome, thereby accounting for a large portion of the cost of the turbocharger. Such conventional turbochargers are typically bolted-on to the cylinder head and include external tubing for supplying high pressure oil to the turbocharger bearing system. However, leakage at the joints of the external tubing can potentially occur over time. While such turbocharger systems do work well for their intended purpose, it is desirable to provide continuous improvement in the relevant art by reducing cost and complexity.

### SUMMARY

In accordance with one example aspect of the invention, a cylinder head assembly for an internal combustion engine is provided. In one example implementation, the assembly includes a cast cylinder head having at least one oil gallery, a turbocharger housing integrally cast with the cylinder head, and a turbocharger cartridge assembly configured to be inserted into the turbocharger housing and including at least one bearing rotatably supporting a shaft coupled between a compressor wheel and a turbine wheel. A lubricant supply system having a lubricant passage formed within the turbocharger housing is configured to supply oil from the oil gallery to the turbocharger cartridge assembly to lubricate the at least one bearing.

In addition to the foregoing, the described cylinder head assembly may include one or more of the following features: wherein the lubricant supply system does not include tubing external to the cast cylinder head and integrally cast turbocharger housing; wherein the lubricant supply system further includes a lubricant supply port extending from the lubricant passage to an oil outlet configured to supply oil to the turbocharger cartridge assembly; wherein the oil outlet is formed within an inlet flange of the turbocharger housing; and a recess formed in the inlet flange about the oil outlet, and a seal disposed within the recess configured to provide sealing between the turbocharger housing and a cartridge housing of the turbocharger cartridge assembly.

In addition to the foregoing, the described cylinder head assembly may include one or more of the following features: a housing flange extending radially outward from the cartridge housing and including a bore formed therein defining an inlet port configured to align with the oil outlet to establish a fluid connection therebetween, wherein the bore is configured to supply oil to the at least one bearing; wherein the bore comprises a first bore, a second bore, a third bore, a fourth bore, and a fifth bore each formed in the cartridge housing; and wherein each of the first, second, third, fourth, and fifth bores are formed via a cross drill.

In addition to the foregoing, the described cylinder head assembly may include one or more of the following features: wherein the first bore includes the inlet port and is fluidly connected to the second bore, which is fluidly connected to the third bore, wherein the fourth bore is fluidly coupled between the third bore and a first bearing of the at least one bearing, and wherein the fifth bore is fluidly coupled between the fourth bore and a second bearing of the at least one bearing; and wherein the turbocharger cartridge assembly further includes a cartridge housing defining an inlet port configured to align with and receive oil from the lubricant passage.

In addition to the foregoing, the described cylinder head assembly may include one or more of the following features: a seal disposed about the inlet port and configured to seal between the cartridge housing and the turbocharger housing; wherein the seal is coupled to an outer surface of the cartridge housing to secure the seal in place during insertion of the turbocharger cartridge assembly within the turbocharger housing; wherein the seal is a three-dimensional O-ring configured to seal the oil in a cylindrical plane; and wherein the seal is a pair of O-rings coupled by a plurality of horizontal seals.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an example cylinder head casting with an integrally cast turbocharger housing in accordance with the principles of the present application;

FIG. 2 is another perspective view of the example cylinder head shown in FIG. 1, in accordance with the principles of the present application;

FIG. 3 is a perspective view of the cylinder head of FIG. 1 with various components assembled on the integrated turbocharger housing, in accordance with the principles of the present application;

FIG. 4 is a perspective view of an example turbocharger cartridge assembly before assembly into the integrated turbocharger housing, in accordance with the principles of the present application;

FIG. 5 is a cross-sectional view of the turbocharger cartridge assembly of FIG. 4 after assembly in the integrated turbocharger housing, in accordance with the principles of the present application;

FIG. 6 is a an example lubricant supply system that may be formed within the cylinder head and integrated turbocharger housing of FIG. 1, in accordance with the principles of the present application;

FIG. 7 is a top view an another example turbocharger cartridge assembly with a first sealing arrangement, in accordance with the principles of the present application;

FIG. 8 is cross-sectional view of the turbocharger cartridge assembly and first sealing arrangement shown in FIG. 7, in accordance with the principles of the present application;

FIG. 9 is a side view of another example turbocharger cartridge assembly with a second sealing arrangement, in accordance with the principles of the present application;

FIG. 10 is a perspective view of an example seal of the sealing arrangement shown in FIG. 9, in accordance with the principles of the present application; and

FIG. 11 is a cross-sectional view of the turbocharger cartridge assembly and second sealing arrangement shown in FIG. 9, in accordance with the principles of the present application.

### DESCRIPTION

Described herein are systems and methods for integrally casting features or components into the cylinder head of an internal combustion engine. Typically, an internal combustion engine is a compact mix of hardware often required to fit in very tight underhood spaces. When components with high mass and density, such as turbocharger systems, are bolted externally to an engine, the resulting structure can potentially affect NVH, dynamics, packaging, decking, durability, etc.

In order to reduce or prevent such issues in the present disclosure, the turbocharger housing is integrated (e.g., cast) into an aluminum cylinder head, which is advantageously configured to reduce engine cost, improve packaging, simplify assembly, reduce number of assembly steps, improve catalyst light off emissions, reduce turbocharger noise (e.g., wastegate resonances, flow noise, rotor group unbalance whine, etc.), improve engine warm up, and improve fuel economy.

Further, the disclosed system includes lubricant supply systems integrated a lubricant passage into the integrally cast turbocharger housing. The lubricant passage is configured to supply high pressure lubricant (e.g., oil) to the bearings of a turbocharger disposed within the turbocharger housing without the need for any external tubing. Various options for sealing the lubricant flow between the integrally cast turbocharger housing and a cartridge housing the bearings are provided.

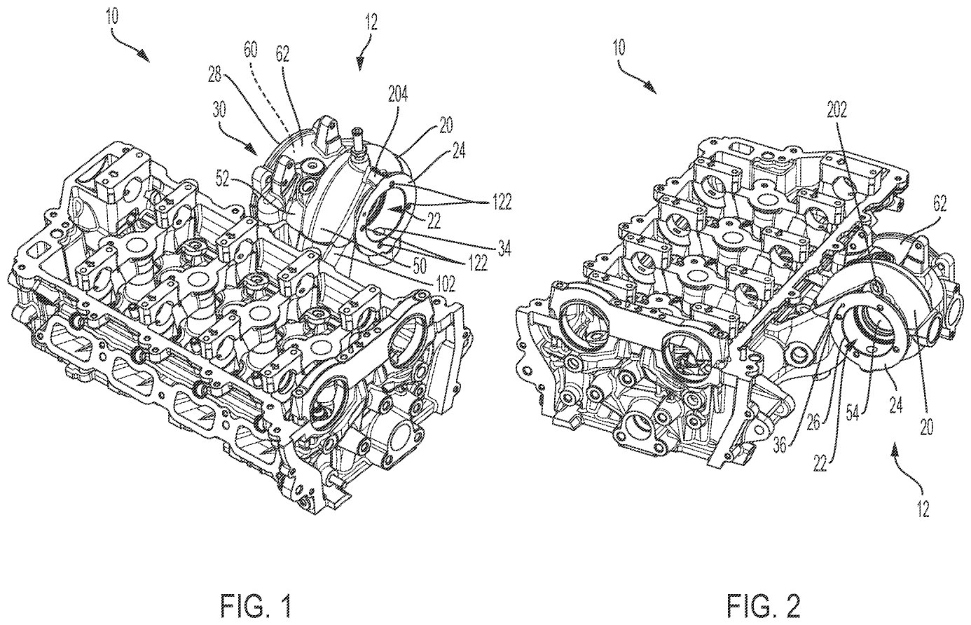

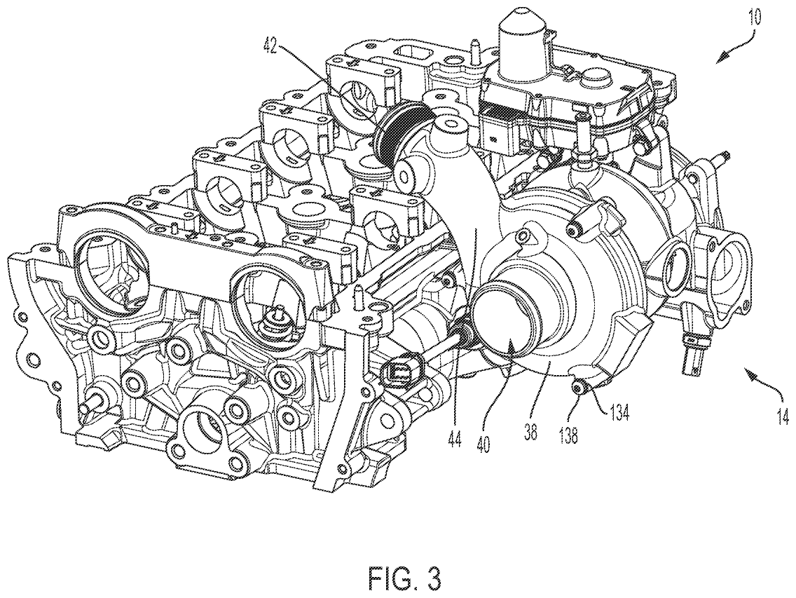

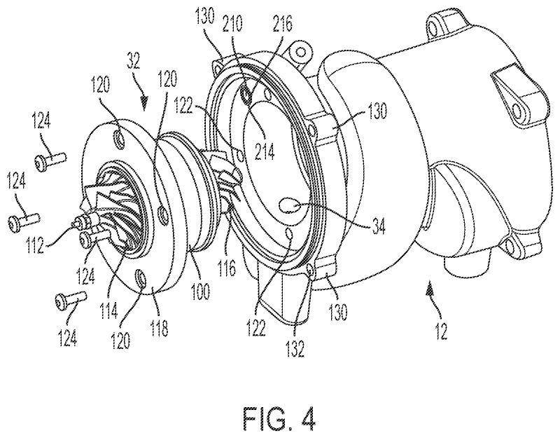

With reference to FIGS. 1 and 2, an example cylinder head for an internal combustion engine is shown and indicated at reference numeral 10. In the example embodiment, the cylinder head 10 includes an integrated (cast-in) turbocharger housing 12 that makes up part of a turbocharger assembly 14 (see FIGS. 3 and 4).

With reference now to FIGS. 1-4, the turbocharger assembly 14 will be described in more detail. In the example embodiment the turbocharger housing 12 is cast with the cylinder head 10 and generally includes a main housing 20 defining a cartridge bore 22, an inlet flange 24 defining a cartridge opening 26, and an outlet flange 28 defining an exhaust outlet 30. The cartridge bore 22 is configured to receive a turbocharger cartridge assembly 32 (FIG. 4), which is configured to align with a drain hole 34 (FIG. 1) for draining a lubricant (e.g., oil) supplied to the cartridge assembly 32 via a lubricant supply system including lubricant supply port 36 (FIG. 2) formed in the turbocharger housing 12, as described herein in more detail.

In the example embodiment, the cartridge opening 26 is configured to receive cartridge assembly 32 therein, followed by a compressor housing 38, to define a compressor inlet 40, as shown in FIG. 3. The compressor inlet 40 is fluidly coupled to a compressor outlet 42 of a compressor outlet duct 44, which is configured to provide compressed intake air to an intake manifold of the engine (not shown). Although illustrated as a separate component, one or more portions of compressor housing 38 may be integrally cast with the turbocharger housing 12 such as, for example the compressor outlet duct 44.

In the example embodiment, the turbocharger housing 12 includes an integrated (cast-in) turbine inlet duct 50 and wastegate inlet duct 52 (FIG. 1), which are respectively coupled to a turbine inlet and a wastegate inlet. Although not shown, the turbine inlet is configured to receive exhaust gas from an exhaust manifold of the engine, and direct the exhaust gas through a turbine outlet formed in the turbocharger housing 12. The turbine outlet is then configured to supply exhaust from the turbine of the cartridge assembly 32 to a wastegate chamber 60 defined by a wastegate housing 62 (FIG. 1) of the turbocharger housing 12. The exhaust from the wastegate chamber 60 is then supplied via exhaust outlet 30 to an exhaust system of the vehicle (not shown).

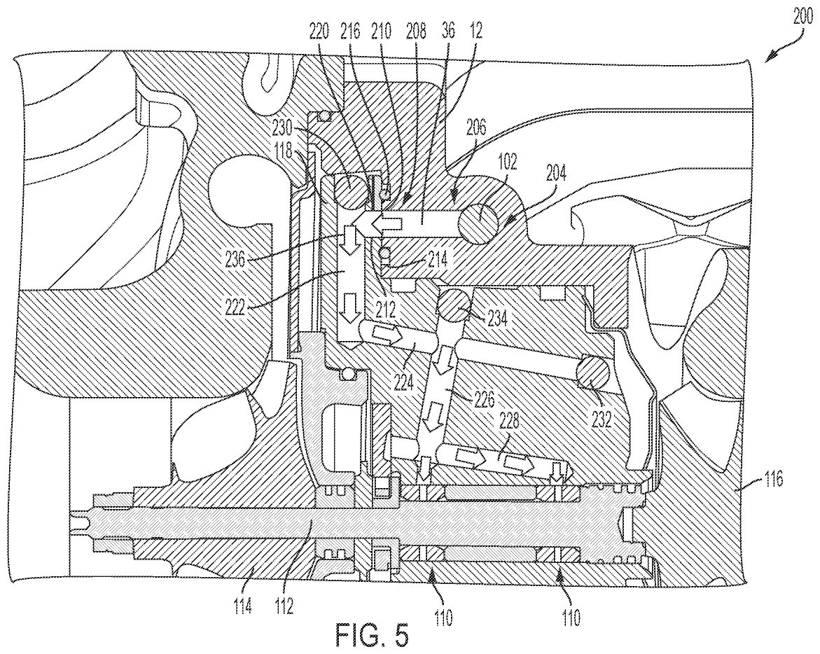

With reference now to FIGS. 4 and 5, the cartridge assembly 32 will be described in more detail. In the example embodiment, the cartridge assembly 32 generally includes a cartridge housing 100 having one or more bearings 110 (FIG. 5) rotatably supporting a shaft 112 that rotatably couples a compressor wheel 114 to a turbine wheel 116. The compressor end of the cartridge housing 100 includes a flange 118 having a plurality of circumferentially located apertures 120 configured to align with corresponding apertures 122 formed on the turbo housing inlet flange 24. A plurality of fasteners 124 (FIG. 4) are inserted through apertures 120, 122 to thereby couple cartridge assembly 32 to the turbocharger housing 12. Once coupled, the turbine wheel 116 is disposed at least partially within the turbine outlet 58.

With reference to FIG. 3, in the example implementation, the compressor housing 38 is configured to couple to housing 12 via radial projections 130 having apertures 132 (FIG. 4) configured to align with apertures 134 formed within the compressor housing 38 and receive fasteners 138. Alternatively, flange 118 can include radial projections with apertures to receive fasteners 138. As previously described, compressor housing 38 defines compressor inlet 40 and compressor outlet 42. The inlet 40 is configured to receive ambient air from an air intake (not shown) and supply the intake air to compressor wheel 114 for subsequent compression. The resulting compressed charge air is then directed to the engine intake manifold via compressor housing outlet 42. Exhaust gas exiting the engine then returned to the turbine side of the turbocharger assembly 14 via the turbine inlet duct 50 and wastegate inlet duct 52.

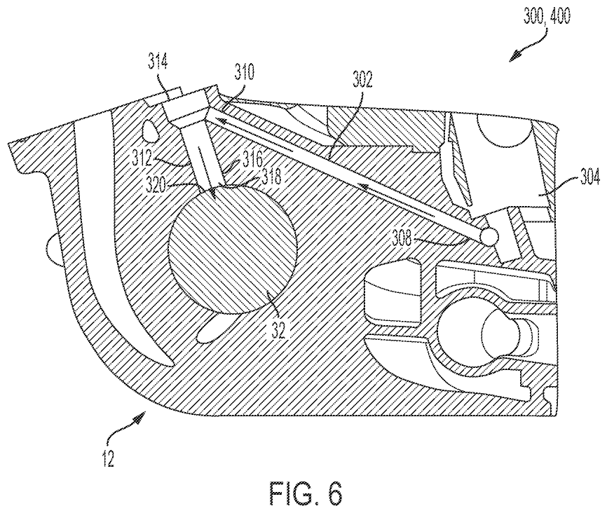

As briefly described above, in the example embodiments, turbocharger housing 12 includes a lubricant passage 102, which fluidly couples a lubricant supply port 36 (FIG. 5) to an oil gallery 104 (e.g., FIG. 6) of the cylinder head 10. In this way, turbocharger housing 12 provides a system for supplying lubricant (e.g., oil) to the cartridge assembly 32 without any external tubes or hoses. Accordingly, FIGS. 1-5 illustrate a first lubricant supply system 200, FIGS. 6-8 illustrate a second lubricant supply system 300, and FIGS. 8-10 illustrate a third lubricant supply system 400 for supplying the lubricant to the one or more bearings 110 of the cartridge assembly.

With reference to now FIGS. 1-5, lubricant supply system 200 will be described in more detail. In the example embodiment, lubricant supply system 200 is configured to supply oil from the cylinder head oil gallery 104 to the cartridge assembly 32 for lubricating the one or more bearings 110 thereof. In the example embodiment, lubricant passage 102 is formed in the turbocharger housing 12 via a cross drill and includes a first end (not shown) fluidly coupled to the oil gallery 104, and a second end 204 (FIG. 1). As a result of the cross drill, lubricant passage second end 204 includes a port 202 (FIG. 2), which is configured to subsequently receive a plug (not shown) for sealing the lubricant passage 102.

As shown in FIG. 5, the lubricant supply port 36 is similarly formed in the turbocharger housing 12 via a cross drill and includes a first end 206 and an opposite second end 208. The first end 206 is fluidly coupled to the lubricant passage second end 204, and the second end 208 defines an oil outlet 210, which is defined in the turbocharger housing inlet flange 24 and configured to align with an inlet port 212 of the cartridge housing flange 118. As illustrated in FIGS. 2 and 4, inlet flange 24 defines a recess 214 about the oil outlet 210 configured to receive and seat a seal 216 (e.g., O-ring) for sealing against the cartridge housing flange 118. In this way, seal 216 establishes a sealed, fluid coupling between the oil outlet 210 and the inlet port 212. Alternatively, recess 214 may be a raised surface.

With continued reference to FIG. 5, in the example embodiment, oil is supplied through the cartridge housing 100 to the bearings 110 via a first bore or cross drill 220, a second bore or cross drill 222, a third bore or cross drill 224, a fourth bore or cross drill 226, and a fifth bore or cross drill 228. The first cross drill 220 defines the inlet port 212, and the second cross drill 222 is sealed by a first seal 230 (e.g., ball plug). Similarly, the third cross drill 224 is sealed by a second seal 232 (e.g., ball plug), and the fourth cross drill 226 is sealed by a third seal 234 (e.g., ball plug).

As shown in FIG. 5 by the arrows representing a high pressure oil feed path 236, oil is supplied through integrated lubricant passage 102, through the lubricant supply port 36, and subsequently through the inlet port 212 into the first cross drill 220. The oil is then directed through the second cross drill 222, the third cross drill 224, and fourth cross drill 226. In the example embodiment, because the cartridge assembly 32 includes two bearings 110, a first portion of the oil feed path 236 is supplied via the fourth cross drill 226 to one bearing 110 while a second portion of the oil feed path 236 is supplied via the fifth cross drill 228 to the other bearing 110. Accordingly, in the example embodiment, the integrally cast turbocharger housing 12 includes lubricant supply system 200 to supply oil from the cylinder head 10 to the turbocharger bearings 110 without any external tubing.

With reference now to FIG. 6-8, lubricant supply system 300 will be described in more detail. As shown in FIG. 6, in the example embodiment, lubricant supply system 300 is configured to supply oil from the cylinder head oil gallery 304 to the cartridge assembly 32 for lubricating the one or more bearings 110 thereof. In the example embodiment, a lubricant passage 302 is formed in the turbocharger housing 12 via a cross drill and includes a first end 308 fluidly coupled to the oil gallery 304, and a second end 310 fluidly coupled to a lubricant supply port 312, which is similarly formed via cross drill. The lubricant supply port 312 includes an open first end 314 and a second end 316 defining an oil outlet 318. The open first end 314 is configured to receive a plug (not shown) for sealing the lubricant passage 302 and supply port 312, and the second end oil outlet 318 is configured to align with an inlet port 320 of the cartridge housing 100.

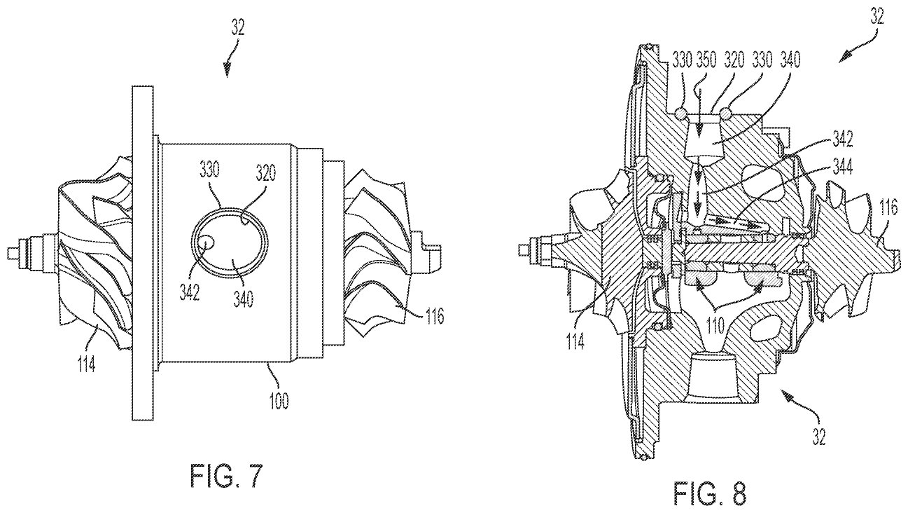

As shown in FIGS. 7 and 8, a 3-dimensional seal 330 (e.g., press in place O-ring) is disposed on a cylindrical or generally cylindrical outer surface of cartridge housing 100 about the inlet port 320 and is configured to seal the oil in a cylindrical plane. In the example embodiment, seal 330 is adhered or mechanically locked to the cartridge housing 100 to secure the seal 330 in place during insertion of the cartridge assembly 32 into the turbocharger housing 12. However, it will be appreciated that seal 330 may be coupled to the cartridge housing 100 in any suitable manner that enables lubricant supply system 300 to function as described herein. For example, a recess may be formed about the oil outlet 318 and/or inlet port 320 to receive at least a portion seal 330 for sealing between the turbocharger housing 12 and the cartridge housing 100.

In the example embodiment, oil is supplied through the cartridge housing 100 to the bearings 110 via a first bore or cross drill 340, a second bore or cross drill 342, and a third bore or cross drill 344. The first cross drill 340 defines the inlet port 320, and the second cross drill 342 is fluidly coupled in-line first cross drill 340 at an opposite end thereof. The third cross drill 344 is fluidly coupled between the second cross drill 342 and the bearings 110.

As shown in FIG. 8 by the arrows representing a high pressure oil feed path 350, oil supplied from the lubricant supply port 312 is directed through the inlet port 320 into the first cross drill 340. The oil is then supplied through the second cross drill 342 to the third cross drill 344. In the example embodiment, cartridge assembly 32 includes two bearings 110, and a first portion of the oil feed path 350 is supplied via the second cross drill 342 to one bearing 110, while a second portion of the oil feed path 350 is supplied via the third cross drill 344 to the other bearings 110. Accordingly, in the example embodiment, the integrally cast turbocharger housing 12 includes lubricant supply system 300 to provide a cost-effective solution to deliver high pressure oil to the turbocharger bearings 110 without the need for external tubes.

With reference now to FIGS. 6 and 9-11, lubricant supply system 400 will be described in more detail. In the example embodiment, lubricant supply system 400 is similar to system 300 except that it includes a seal 430 rather than seal 330. Lubricant supply system 400 is configured to include the oil supply arrangement shown in FIG. 6, including the lubricant passage 302 and lubricant supply port 312 for supplying high pressure oil to the cartridge assembly 32.

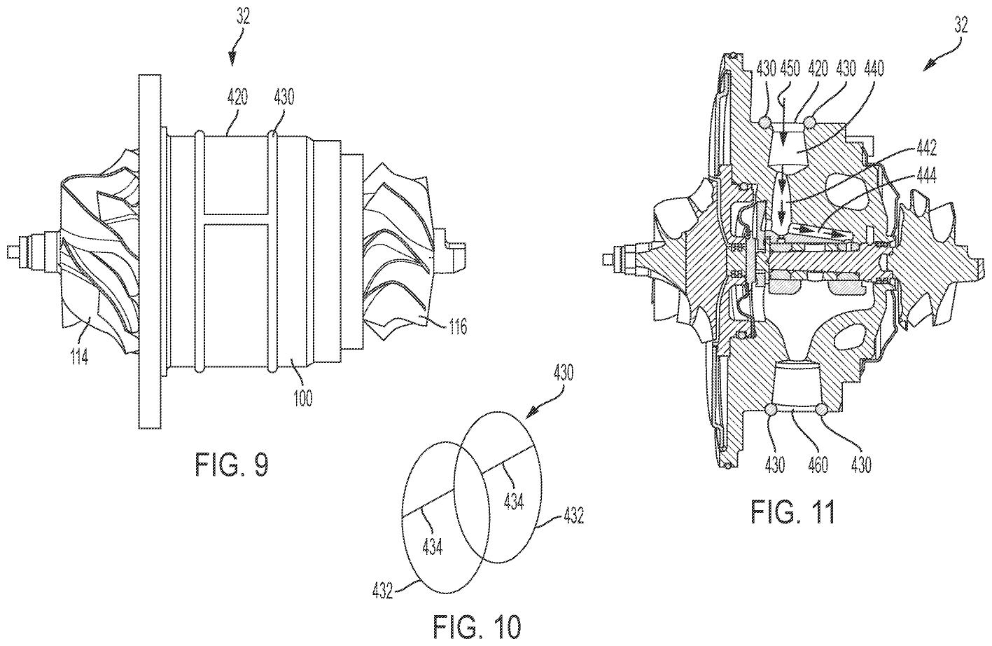

As shown in FIGS. 9-11, seal 430 is disposed about the outer surface or outer circumference of cartridge housing 100 about an inlet port 420, which is configured to align with the oil outlet 318 formed in the turbocharger housing 12. The seal is configured to seal the oil in a cylindrical plane and may be adhered or mechanically locked to the cartridge housing 100 to secure the seal 430 in place during insertion of the cartridge assembly 32 into the turbocharger housing. However, it will be appreciated that seal 430 may be coupled to the cartridge housing 100 in any suitable manner that enables lubricant supply system 400 to function as described herein. As shown in FIG. 10, in the example embodiment, seal 430 is an H-shaped seal formed from two circular O-rings 432 and two horizontal seals 434 extending therebetween.

In the example embodiment, oil is supplied through the cartridge housing 100 to the bearings 110 via a first bore or cross drill 440, a second bore or cross drill 442, and a third bore or cross drill 444. The first cross drill 440 defines the inlet port 420, and the second cross drill 442 is fluidly coupled in-line with the first cross drill 440 at an opposite end thereof. The third cross drill 444 is fluidly coupled between the second cross drill 442 and the bearings 110.

As shown in FIG. 11 by the arrows representing a high pressure oil feed path 450, oil supplied from the lubricant supply port 312 is directed through the inlet port 420 into the first cross drill 440. The oil is then directed through the second cross drill 442 to the third cross drill 444. In the example embodiment, cartridge assembly 32 includes two bearings 110, and a first portion of the oil feed path 450 is supplied via the second cross drill 442 to one bearing 110 while a second portion of the oil feed path 450 is supplied via the third cross drill 444 to the other bearings 110. Once the bearings 110 are lubricated, the oil flows by gravity through a drain bore 460 to drain hole 34 (FIG. 1). As shown in FIG. 11, drain bore 460 is also sealed by the seal 430 between the cartridge housing 100 and the turbocharger housing 12.

As such, in the example embodiment, high pressure oil is supplied to the turbocharger bearings 110 through passages drilled into the cylinder head 10, turbocharger housing 12, and cartridge housing 100. To prevent oil leakage around the cartridge assembly 32, a custom gasket or seal 430 is used, which acts as a seal between the outer surface of cartridge housing 100 and the turbocharger housing 12. The H-shaped seal 430 can be made by molding two circular O-rings 432 and the two horizontal seals 434. In the example embodiment, the circular O-rings 432 prevent oil leakage along the longitudinal axis of the cartridge and the horizontal seals 434 prevent the high pressure oil from leaking along the circumference of the cartridge housing 100 and finding its way to the oil drain side. Accordingly, such integration of the lubricant supply system 400 into the turbocharger housing 12 provides another cost-effective solution to deliver high pressure oil to the turbocharger bearings without the need for external tubes.

Described herein are systems and methods for internally supplying lubricating oil to the bearings of a turbocharger cartridge assembly. By integrally casting a turbocharger housing with the cylinder head, lubricating oil from the cylinder head oil gallery can be supplied to the turbocharger cartridge without external oil feed tubes, thereby simplifying the system, reducing packaging space, and reducing costs. Various cost-effective sealing arrangements are provided to establish a fluid seal between the cartridge assembly and the turbocharger housing to prevent oil leaks.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A cylinder head assembly for an internal combustion engine, the assembly comprising:
a cast cylinder head having at least one oil gallery;
a turbocharger housing integrally cast with the cylinder head;
a turbocharger cartridge assembly configured to be inserted into the turbocharger housing and including at least one bearing rotatably supporting a shaft coupled between a compressor wheel and a turbine wheel; and
a lubricant supply system having a lubricant passage formed within the turbocharger housing and configured to supply oil from the at least one oil gallery to the turbocharger cartridge assembly to lubricate the at least one bearing.

2. The cylinder head assembly of claim 1, wherein the lubricant supply system does not include tubing external to the cast cylinder head and integrally cast turbocharger housing.

3. The cylinder head assembly of claim 1, wherein the lubricant supply system further includes a lubricant supply port extending from the lubricant passage to an oil outlet configured to supply oil to the turbocharger cartridge assembly.

4. The cylinder head assembly of claim 3, wherein the oil outlet is formed within an inlet flange of the turbocharger housing.

5. The cylinder head assembly of claim 4, further comprising:
a recess formed in the inlet flange about the oil outlet; and
a seal disposed within the recess and configured to provide sealing between the turbocharger housing and a cartridge housing of the turbocharger cartridge assembly.

6. The cylinder head assembly of claim 5, further comprising a housing flange extending radially outward from the cartridge housing and including a bore formed therein defining an inlet port configured to align with the oil outlet to establish a fluid connection therebetween, wherein the bore is configured to supply oil to the at least one bearing.

7. The cylinder head assembly of claim 6, wherein the bore comprises a first bore, a second bore, a third bore, a fourth bore, and a fifth bore each formed in the cartridge housing.

8. The cylinder head assembly of claim 7, wherein each of the first, second, third, fourth, and fifth bores are formed via a cross drill.

9. The cylinder head assembly of claim 7, wherein the first bore includes the inlet port and is fluidly connected to the second bore, which is fluidly connected to the third bore,
wherein the fourth bore is fluidly coupled between the third bore and a first bearing of the at least one bearing, and
wherein the fifth bore is fluidly coupled between the fourth bore and a second bearing of the at least one bearing.

10. The cylinder head assembly of claim 1, wherein the turbocharger cartridge assembly further includes a cartridge housing defining an inlet port configured to align with and receive oil from the lubricant passage.

11. The cylinder head assembly of claim 1, further comprising a seal disposed about the inlet port and configured to seal between the cartridge housing and the turbocharger housing.

12. The cylinder head assembly of claim 11, wherein the seal is coupled to an outer surface of the cartridge housing to secure the seal in place during insertion of the turbocharger cartridge assembly within the turbocharger housing.

13. The cylinder head assembly of claim 11, wherein the seal is a three-dimensional O-ring configured to seal the oil in a cylindrical plane.

14. The cylinder head assembly of claim 11, wherein the seal is a pair of O-rings coupled by a plurality of horizontal seals.
